(19) United States
(12) Patent Application Publication
(10) Pub. No.: US 2016/0037903 A1
(43) Pub. Date: Feb. 11, 2016

(54) SYSTEMS, METHODS AND APPARATUS FOR TRACKING A TOOTHBRUSH

(71) Applicant: Rakesh M. Lal, Cambridge, MA (US)

(72) Inventor: Rakesh M. Lal, Cambridge, MA (US)

(21) Appl. No.: 14/815,091

(22) Filed: Jul. 31, 2015

Related U.S. Application Data
(60) Provisional application No. 61/999,743, filed on Aug. 5, 2014.

(51) Int. Cl. A46B 15/00; G01B 11/00

(52) U.S. Cl. CPC A46B 15/0006; A46B 15/0002; A46B 15/0012; A46B 15/0014; G01B 11/00

(57) ABSTRACT

Systems, methods and apparatus are provided through which in some aspects the position of a toothbrush is tracked relative to a user's dentition, while brushing. In some aspects, a toothbrush system includes a handle, a brush head, an illumination system, a camera system operable to acquire a set of light field images, and a set of machine readable instructions operable to receive the set of light field images and determine a relative transformation of the camera system associated with each light field image. In another aspect, a method of tracking the position of a toothbrush as it brushes a dental structure includes illuminating the dental structure, capturing a set of light field images of the dental structure, computing a transformation relative to the dental structure associated with each light field image, and determining a set of positions of the toothbrush relative to the dental structure based on the transformation.

### RELATED APPLICATION

This application claims the benefit of U.S. Provisional Application Ser. No. 61/999,743, filed Aug. 5, 2014 under 35 U.S.C. 119(e).

### FIELD OF THE INVENTION

This invention relates generally to tracking the three dimensional position of a toothbrush relative to a user's dentition while being used to brush the teeth, and more particularly to tracking the three dimensional position of a toothbrush and associating the three dimensional position relative to the user's dentition with various signals acquired by other sensors embedded within the same toothbrush.

### BACKGROUND OF THE INVENTION

Most toothbrushes on the market today are simple devices that comprise a brush head and a handle, with no electronic sensing technology built in to them. Though they serve the primary function of cleaning a person's dental tissue (teeth, gums, etc.), there is a great deal of potential to understanding one's overall oral health by leveraging the simple toothbrush to capture various physiological signals during the course of brushing. Effectively utilizing physiological signals captured during the course of brushing however usually requires information related to the segment, component, part and type of the dental tissue from which the signal was acquired. As such, tracking the position of the toothbrush relative to a user's dentition during the process of brushing one's teeth is critical to discerning trends in an individual's oral health.

Some more advanced toothbrush systems employ tracking of brush strokes via simple sensors such as accelerometers or gyroscopes embedded within the brush. Other technologies such as position sensing may be capable of tracking the three dimensional position of a toothbrush relative to a stationary reference, such as the toothbrush's charging base. The limitation of these approaches is that they do not track the position

In particular, one of skill in the art will readily appreciate that the names of the methods and apparatus are not intended to limit aspects. Furthermore, additional methods and apparatus can be added to the components, functions can be rearranged among the components, and new components to correspond to future enhancements and physical devices used in aspects can be introduced without departing from the scope of aspects. One of skill in the art will readily recognize that aspects are applicable to future physiological and oral signals that can be acquired, derived or interpreted, different methods of acquiring three dimensional scan and position tracking data, and new algorithms to infer three dimensional positions from a light field image.

The terminology used in this application is meant to include all systems to track the three dimensional position of a toothbrush and index various acquired oral signal data using the tracked position, and alternate technologies which provide the same functionality as described herein. relative to the user's dentition, and thus any motion of the teeth, jaw, head, or overall body may result in spurious data.

Other methods of monitoring oral health may include more sophisticated devices such as X-ray scanners, CT scanners, optical imaging scanners, or other imaging devices typically available at a dentist's office. The limitation of these devices is that their use is restricted to a patient's visit to a dentist, thus reducing the number of time points that can be measure. This in turn reduces the ability to discern any oral health trends associated with an individual.

For the reasons stated above, and for other reasons stated below which will become apparent to those skilled in the art upon reading and understanding the present specification, there is a need in the art for a toothbrush that is capable of being tracked relative to a user's dentition, during the process of brushing. There is also a need for monitoring other physiological signals and parameters as they relate to a person's dentition.

### BRIEF DESCRIPTION OF THE INVENTION

The above-mentioned shortcomings, disadvantages and problems are addressed herein, which will be understood by reading and studying the following specification.

In one aspect, a toothbrush system includes a handle, a brush head, an illumination system embedded within the brush head, a camera system embedded within the brush head, operable to acquire a set of light field images, and a set of machine readable instructions embodied in a non-transitory computer readable storage medium, operable to receive the set of light field images, and further operable to determine a relative transformation of the camera system associated with each light field image in the set.

In another aspect, a method of tracking the position of a toothbrush as it brushes a dental structure includes illuminating the dental structure, capturing a set of light field images of the dental structure, computing a transformation associated with each light field image in the set wherein the transformation is relative to the dental structure, and determining a set of positions of the toothbrush relative to the dental structure based on the transformation associated with each light field image in the set.

Apparatus, systems, and methods of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a block diagram illustrating a system of tracking a toothbrush relative to a user's dentition.

FIG. 2 is a cross section block diagram of an apparatus according to an aspect to track the three dimensional position of a toothbrush.

FIG. 3 is a cross section block diagram of an apparatus according to an aspect to accurately track the three dimensional position of a toothbrush and associate the three dimensional position relative to a user's dentition with various signals acquired by other sensors embedded within the same toothbrush.

FIG. 4 is a cross section block diagram of an apparatus according to an aspect to accurately track the three dimensional position of a toothbrush and associate the three dimensional position relative to a user's dentition in which the three dimensional position is transmitted to a visualization system, and displayed on a rendering of the user's dentition.

FIG. 5 is a cross section block diagram of an apparatus according to an aspect to accurately track the three dimensional position of a toothbrush and associate the three dimensional position relative to a user's dentition with various signals acquired by other sensors embedded within the same toothbrush, with a disposable element that can be removed from the main body of the toothbrush.

FIG. 6 is a cross section block diagram of an apparatus according to an aspect to accurately track the three dimensional position of a toothbrush using a light field camera and a set of position sensing elements.

FIG. 7 is a flowchart of a method to render the three dimensional positions of a toothbrush on a visual representation of a user's dentition.

FIG. 8 is a flowchart of method 800 to render a set of sensed physiological values on a visual representation of a user's dentition.

FIG. 9 is a flowchart of a method to render the three dimensional positions of a toothbrush on a visual representation of a user's dentition by sensing the position of the toothbrush relative to a stationary base.

### DETAILED DESCRIPTION OF THE INVENTION

In the following detailed description, reference is made to the accompanying drawings that form a part hereof, and in which is shown by way of illustration specific aspects which may be practiced. These aspects are described in sufficient detail to enable those skilled in the art to practice the aspects, and it is to be understood that other aspects may be utilized and that logical, mechanical, electrical and other changes may be made without departing from the scope of the aspects. The following detailed description is, therefore, not to be taken in a limiting sense.

The detailed description is divided into four sections. In the first section, a system level overview is described. In the second section, apparatus of aspects are described. In the third section, aspects of methods are described. Finally, in the fourth section, a conclusion of the detailed description is provided.

### System Level Overview

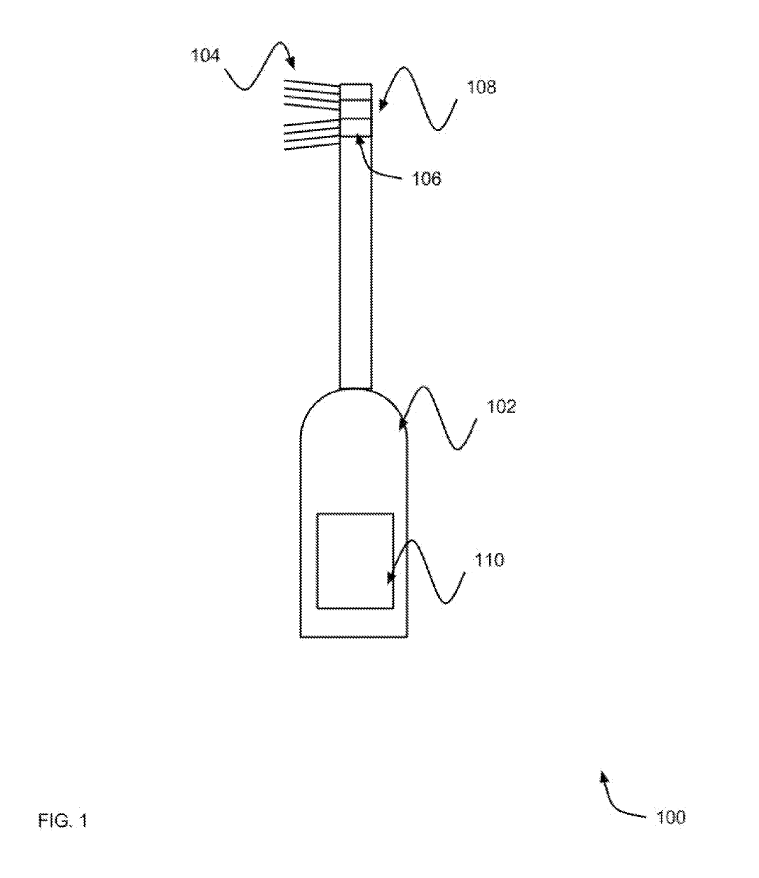

FIG. 1 is a block diagram illustrating a system of tracking a toothbrush. System 100 solves the need in the art to accurately track the three dimensional position of a toothbrush relative to a user's dentition.

System 100 includes a handle 102, a brush head 104, an illumination system 106 embedded within the brush head, a camera system 108 embedded within the brush head and operable to acquire a set of light field images, and a set of machine readable instructions embodied in a non-transitory computer readable storage medium 110, operable to receive the set of light field images, and further operable to determine a relative transformation of the camera system associated with each light field image in the set.

Component 106 solves the need in the art to provide sufficient lighting during the process of acquiring image data used in tracking the three dimensional position of the toothbrush system.

Component 108 solves the need in the art to acquire a set of light field images of a user's dentition, sufficiently illuminated by the illumination system, during the process of the user brushing his teeth.

Component 110 solves the need in the art to determine the three dimensional position of the camera system embedded within the toothbrush system, based on the set of light field images acquired by the camera system. This is accomplished by estimating the relative transformation of the camera system associated with each light field image in the set based on the partial overlap of those images.

The system level overview of the operation of an aspect is described in this section of the detailed description. The illumination system provides lighting to the dental scene being imaged, and in one aspect also projects a pattern of edges onto the dental scene.

The camera system captures a set of light field images over time of the dental scene being imaged, including the light from the illumination system. In one aspect the light from the illumination system includes a pattern of edges projected onto the dental scene. In another aspect a light field image includes an image intensity function that varies with spatial co-ordinates as well as angular co-ordinates. In one aspect, mathematical constructs exist to convert a light field image to a set of standard images each of which include an intensity function that varies with spatial co-ordinates only, wherein each image focused at a different focal depth.

The set of machine readable instructions embodied in a non-transitory computer readable storage medium receive the set of light field images, which in one aspect may further include a video stream. In another aspect, the set of machine readable instructions is further operable to construct a set of images with varying focal depth associated with each light field image in the set of light field images, wherein each image in the set of images with varying focal depth captures the illumination pattern captured in each light field image as a set of edges, extract the set of edges in each image of varying focal depth and compute an edge strength corresponding to each edge, and construct a point cloud associated with each light field image, based on the set of edges and corresponding edge strengths associated with each image in the set of images with varying focal depth. In another aspect, the set of machine readable instructions is further operable to compute a rigid transformation associated with each point cloud relative to the first point cloud and based on the partial overlap between pairs of point clouds, and determine the relative transformation of the camera system associated with each light field image in the set based on the rigid transformation associated with each point cloud.

While the system 100 is not limited to any particular illumination system, camera system and set of machine readable instructions, for sake of clarity a simplified illumination system, camera system and machine readable instructions are described.

### Apparatus Aspects

In the previous section, a system level overview of the operation of an aspect was described. In this section, the particular apparatus of such an aspect are described by reference to a series of diagrams.

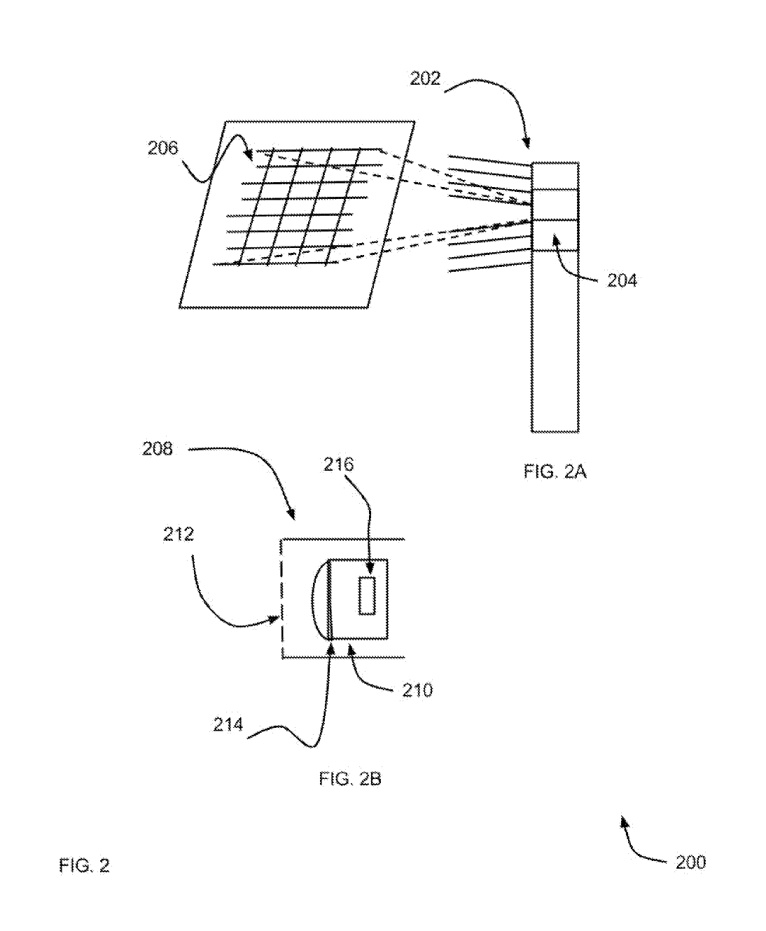

FIG. 2 is a cross section block diagram of apparatus 200 according to an aspect to track the three dimensional position of a toothbrush. Apparatus 200 solves the need in the art accurately track the three dimensional position of a toothbrush relative to a user's dentition.

Apparatus 200 includes a brush head 202 which encapsulates an illumination system 204. In one aspect the illumination system includes a set of illumination elements 208 operable to project a pattern of light 206 onto the scene being imaged. In another aspect, each illumination element further includes an illumination source 210 and a grating 212, wherein the grating blocks some illumination paths resulting in a projected pattern. In another aspect, the illumination source further includes a light source 214 operable to generate light, and a lens 216, operable to collect the light from the light source into a light beam.

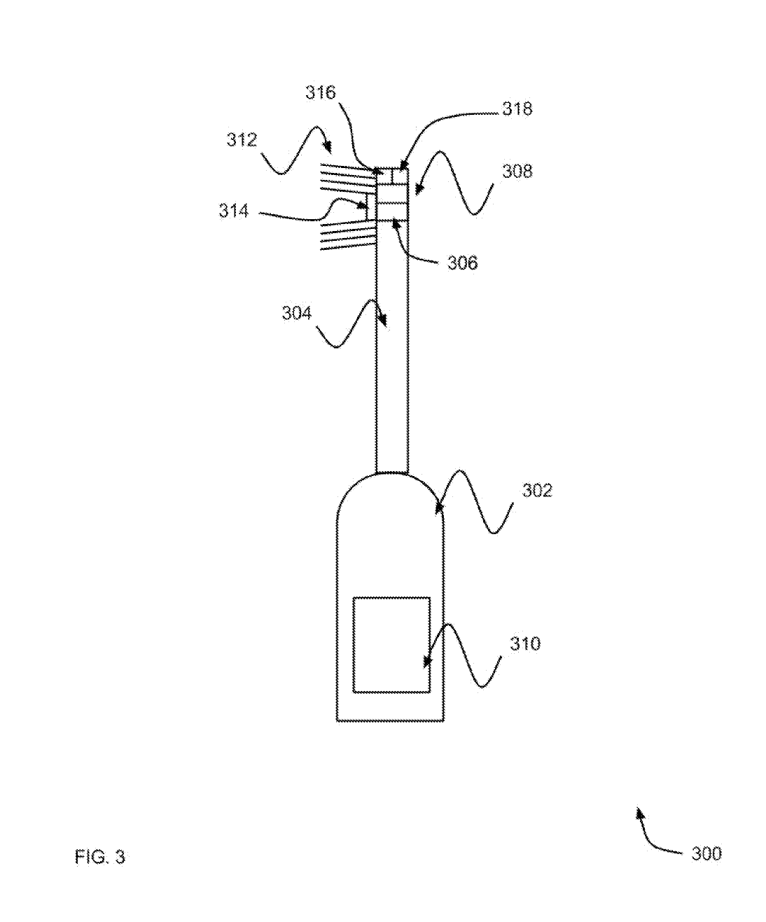

FIG. 3 is a cross section block diagram of apparatus 300 according to an aspect to accurately track the three dimensional position of a toothbrush and associate the three dimensional position relative to a user's dentition with various signals acquired by other sensors embedded within the same toothbrush. Apparatus 300 solves the need in the art to associate the output of sensors embedded within a toothbrush with a segment or region of a user's dentition.

Apparatus 300 includes a handle 302, a brush head 304, an illumination system 306 embedded within the brush head, a camera system 308 embedded within the brush head and operable to acquire a set of light field images, and a set of machine readable instructions embodied in a non-transitory computer readable storage medium 310, operable to receive the set of light field images, and further operable to determine a relative transformation of the camera system associated with each light field image in the set.

Apparatus 300 further includes a set of bristles 312, wherein the set of bristles do not occlude the view of the camera system, and wherein the set of bristles is comprised of individual bristle bundles, an optically transparent protective covering 314 over the camera system and illumination system, a first set of sensors 316, and a second set of sensors 318, wherein each sensor in the first and second set of sensors is operable to sense a set of samples of a signal as a function of time. In one aspect, the machine readable instructions is further operable to associate the time associated with each sample in the signal with a light field image in the set of light field images, and thus associate each sample of the signal with a three dimensional position relative to the user's dentition.

In one aspect, the first set of sensors further includes a temperature sensor operable to sense the surrounding temperature samples as a function of time. In another aspect, the first set of sensors further includes a pH sensor operable to sense the surrounding pH samples as a function of time. In yet another aspect, the first set of sensors further includes a pressure sensor operable to sense the pressure applied to each bristle bundle in the set of bristles as a function of time.

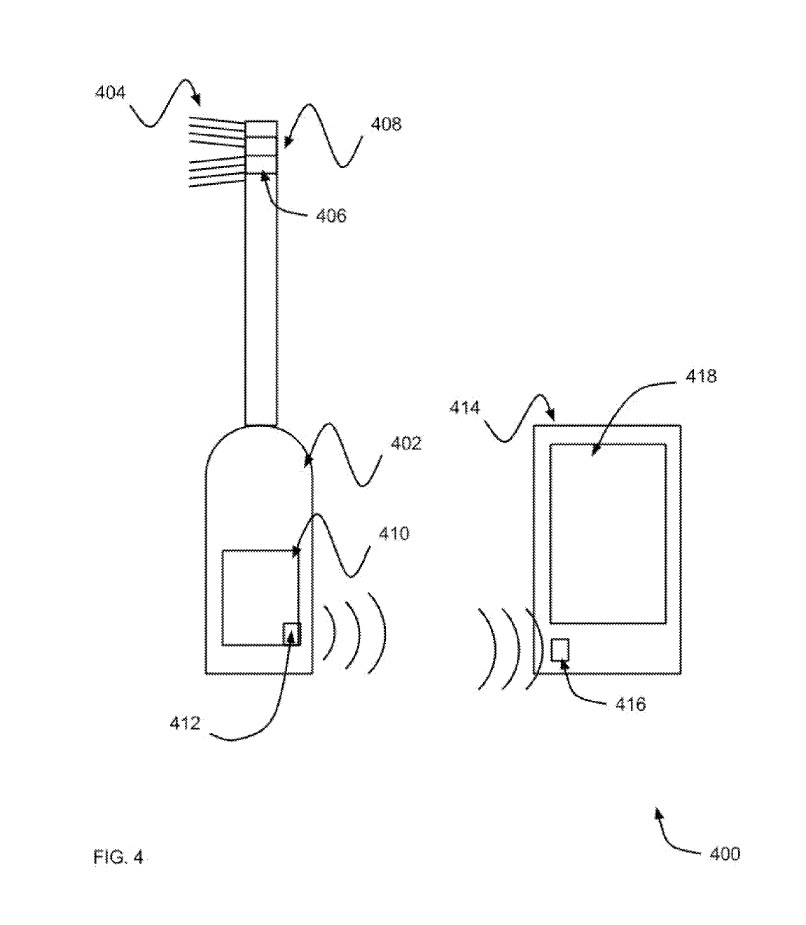

FIG. 4 is a cross section block diagram of apparatus 400 according to an aspect to accurately track the three dimensional position of a toothbrush and associate the three dimensional position relative to a user's dentition in which the three dimensional position is transmitted to a visualization system, and displayed on a rendering of the user's dentition. Apparatus 400 solves the need in the art to communicate and display the three dimensional position of the toothbrush to the user relative to the user's dentition.

Apparatus 400 includes a handle 402, a brush head 404, an illumination system 406 embedded within the brush head, a camera system 408 embedded within the brush head and operable to acquire a set of light field images, and a set of machine readable instructions embodied in a non-transitory computer readable storage medium 410, operable to receive the set of light field images, and further operable to determine a relative transformation of the camera system associated with each light field image in the set.

Apparatus 400 further includes a transmitter module 412 operable to transmit the relative three dimensional positions of the camera system over time, and a visualization system 414. In one aspect, the visualization system further includes a receiver module 416 operable to receive the relative three dimensional position of the camera system, and a display system 418, operable to render a representation of the brush head within a virtual three dimensional space, based on the relative three dimensional position of the camera system.

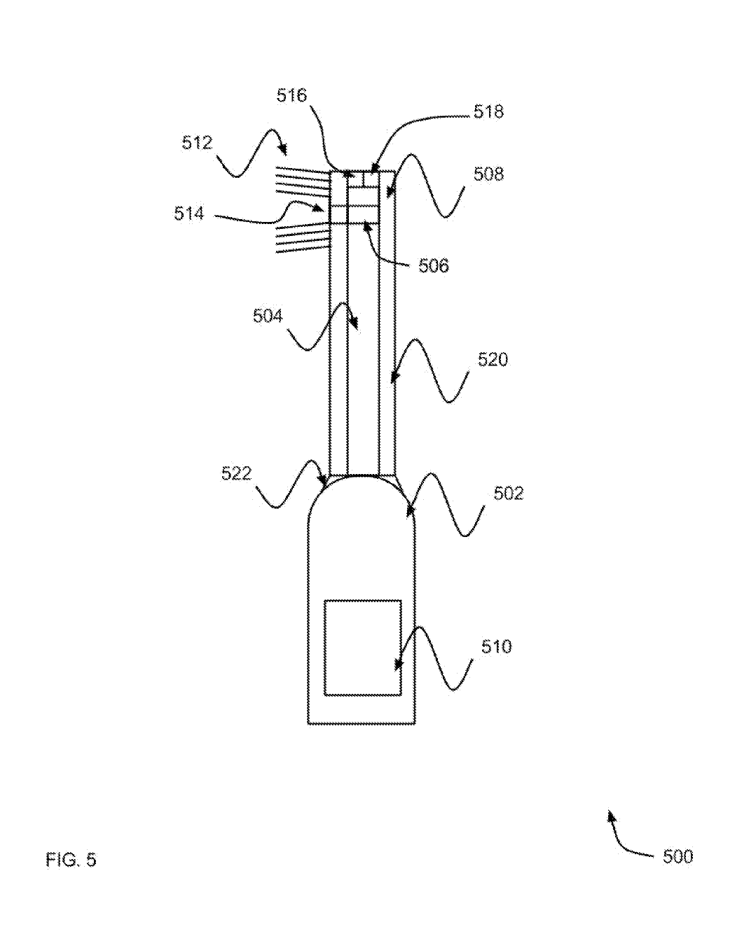

FIG. 5 is a cross section block diagram of apparatus 500 according to an aspect to accurately track the three dimensional position of a toothbrush and associate the three dimensional position relative to a user's dentition with various signals acquired by other sensors embedded within the same toothbrush, with a disposable element that can be removed from the main body of the toothbrush. Apparatus 500 solves the need in the art to associate the output of sensors embedded within a toothbrush with a segment or region of a user's dentition from within a disposable element of the toothbrush.

Apparatus 500 includes a handle 502, an internal brush head shaft 504, an illumination system 506 embedded within the internal brush head shaft, a camera system 508 embedded within the internal brush head shaft and operable to acquire a set of light field images, a set of machine readable instructions embodied in a non-transitory computer readable storage medium 510, operable to receive the set of light field images, and further operable to determine a relative transformation of the camera system associated with each light field image in the set, a first set of sensors 516, a second set of sensors 518, wherein each sensor in the first and second set of sensors is operable to sense a set of samples of a signal as a function of time.

Apparatus 500 further includes a disposable outer housing 520, wherein the disposable outer housing can be removed and reattached from the internal shaft via a keying mechanism 522 located at the junction with the handle. In one aspect, the disposable outer housing includes a set of bristles 512, wherein the set of bristles do not occlude the view of the camera system, and wherein the set of bristles is comprised of individual bristle bundles, and an optically transparent protective covering 514 over the camera system and illumination system.

In one aspect, the machine readable instructions is further operable to associate the time associated with each sample in the signal with a light field image in the set of light field images, and thus associate each sample of the signal with a three dimensional position relative to the user's dentition.

In one aspect, the first set of sensors further includes a temperature sensor operable to sense the surrounding temperature samples as a function of time. In another aspect, the disposable outer housing further includes a thermally conducting material coupled to the temperature sensor and operable to transmit temperature changes to the temperature sensor. In another aspect, the disposable outer housing further includes an opening coupled to the temperature sensor and wherein the temperature sensor is thermally isolated from the other components of the internal shaft.

In another aspect, the first set of sensors further includes a pH sensor operable to sense the surrounding pH samples as a function of time. In another aspect, the disposable outer housing further comprises an opening coupled to the pH sensor and wherein the pH sensor is isolated from the other components of the internal shaft. In yet another aspect, the first set of sensors further includes a pressure sensor operable to sense the pressure applied to each bristle bundle in the set of bristles as a function of time.

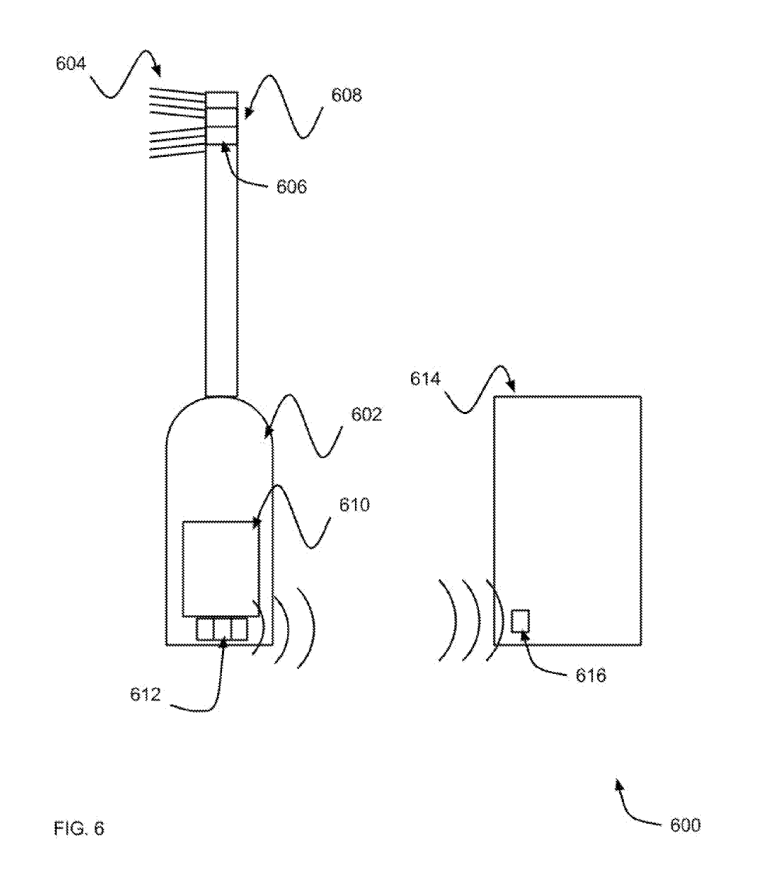

FIG. 6 is a cross section block diagram of apparatus 600 according to an aspect to accurately track the three dimensional position of a toothbrush using a light field camera and a set of position sensing elements.

Apparatus 600 includes a handle 602, a brush head 604, an illumination system 606 embedded within the brush head, a camera system 608 embedded within the brush head and operable to acquire a set of light field images, a set of machine readable instructions embodied in a non-transitory computer readable storage medium 610, operable to receive the set of light field images, and further operable to determine a relative transformation of the camera system associated with each light field image in the set, and a stationary base 614 operable to sense the position of the brush head relative to the stationary base. In one aspect, the handle further includes a first transceiver 612 operable to emit and receive a set of signals, and wherein the stationary base further comprises a second transceiver 616 operable to emit and receive the set of signals and further operable to determine the position of the brush head relative to the stationary base, based on the set of signals.

In one aspect the first transceiver further includes a set of at least three transmitters each operable to emit a signal. In another aspect, each transmitter further includes an infrared transmitter and the second transceiver further comprises an infrared imaging sensor. In yet another aspect, each transmitter further comprises a radiofrequency transmitter and the second transceiver further comprises a radiofrequency receiver. In yet another aspect, each transmitter further comprises an acoustic transmitter and the second transceiver further comprises an acoustic receiver. In another aspect, the second transceiver further comprises a receiver operable to receive the set of signals and further operable to determine the position of the brush head relative to the stationary base, based on the temporal difference of receiving each of the set of signals. In another aspect, the second transceiver further comprises a receiver operable to receive the set of signals and further operable to determine the position of the brush head relative to the stationary base, based on the attenuation of each of the set of signals.

In yet another aspect, the set of machine readable instructions further comprises a set of machine readable instructions embodied in a non-transitory computer readable storage medium, operable to receive the set of light field images, and further operable to determine a relative transformation of the camera system associated with each light field image in the set based on the light field images and the sensed position of the brush head relative to the stationary base.

### Method Aspects

In the previous section, apparatus of the operation of an aspect was described. In this section, the particular methods performed by usage of such an aspect are described by reference to a series of flowcharts.

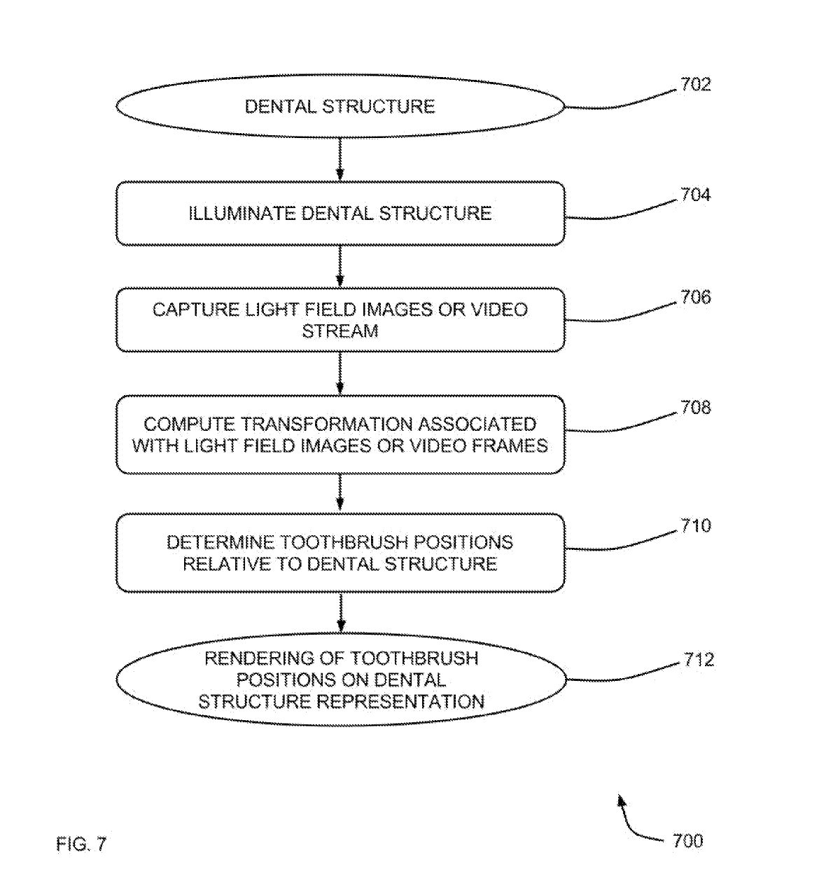

FIG. 7 is a flowchart of method 700 to render the three dimensional positions of a toothbrush on a visual representation of a user's dentition. Method 700 solves the need in the art to visualize the three dimensional position of a toothbrush relative to a user's dentition while brushing.

Method 700 includes a dental structure being brushed 702, illuminating the dental structure 704, capturing a set of light field images or video stream of the dental structure 706, computing a transformation associated with each light field image in the set 708 wherein the transformation is relative to the dental structure, determining a set of positions of the toothbrush relative to the dental structure 710 based on the transformation associated with each light field image in the set, and yielding a rendering of the three dimensional positions of the toothbrush relative to a representation of the dental structure 712.

In one aspect, illuminating the dental structure further includes illuminating the dental structure with a pattern of light. In another aspect, capturing a set of light field images further includes capturing a set of light field images wherein each light field image captures the pattern of light. In another aspect, computing the transformation associated with each light field image or video stream further includes constructing a set of images with varying focal depth associated with each light field image in the set of light field images, wherein each image in the set of images with varying focal depth captures the pattern of light captured in each light field image as a set of edges, extracting the set of edges in each image of varying focal depth and compute an edge strength corresponding to each edge, and constructing a point cloud associated with each light field image, based on the set of edges and corresponding edge strengths associated with each image in the set of images with varying focal depth. In yet another aspect, determining a set of positions of the toothbrush relative to the dental structure further includes computing a rigid transformation associated with each point cloud relative to the first point cloud and based on the partial overlap between pairs of point clouds, and determining the relative transformation associated with each light field image in the set based on the rigid transformation associated with each point cloud. In yet another aspect, computing the rigid transformation associated with each point cloud further includes iteratively computing a point cloud representing the dental structure.

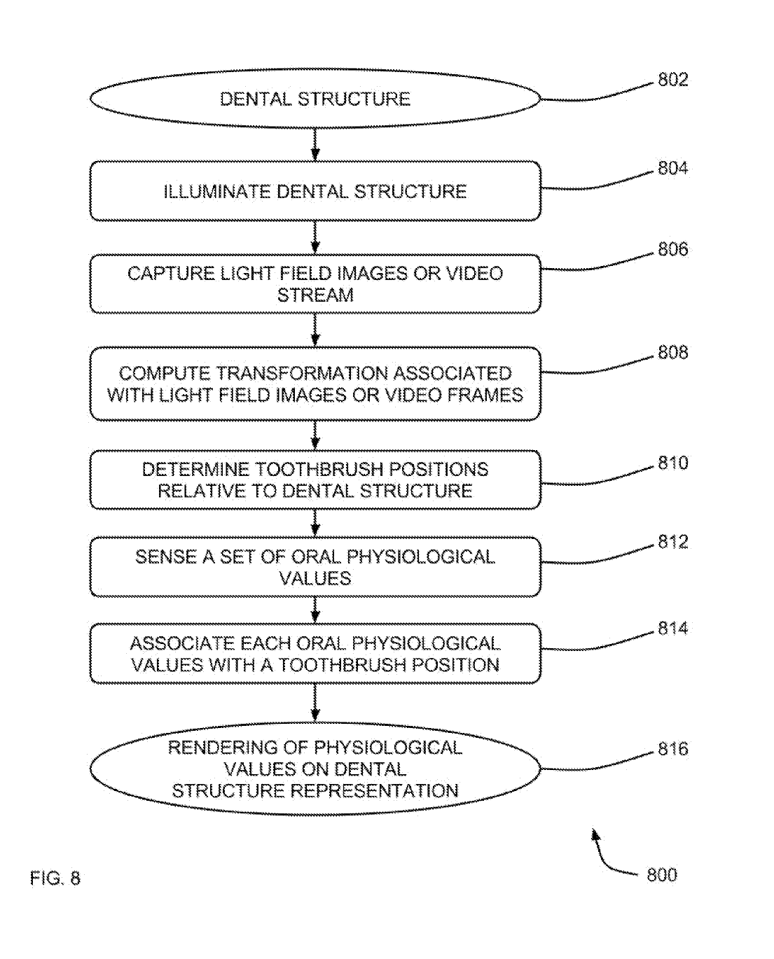

FIG. 8 is a flowchart of method 800 to render a set of sensed physiological values on a visual representation of a user's dentition. Method 800 solves the need in the art to visualize various sets of sensed physiological values of relative to a user's dentition while brushing.

Method 800 includes a dental structure being brushed 802, illuminating the dental structure 804, capturing a set of light field images or video stream of the dental structure 806, computing a transformation associated with each light field image in the set 808 wherein the transformation is relative to the dental structure, determining a set of positions of the toothbrush relative to the dental structure 810 based on the transformation associated with each light field image in the set, sensing a set of oral physiological values 812, associating each oral physiological value sensed with a toothbrush position relative to the dental structure 814, and yielding a rendering of the set of oral physiological values relative to a representation of the dental structure 816.

In some aspects associating each oral physiological value sensed with a toothbrush position relative to the dental structure further includes associating each oral physiological value in the set with a light field image based on the time the oral physiological value was sensed relative to the time each light field image was acquired, and associating each oral physiological value in the set with a position of the toothbrush based on the light field image the oral physiological value is associated with. In another aspect, the set of oral physiological values further includes a set of pH values. In another aspect, the set of oral physiological values further includes a set of temperature values. In yet another aspect, the set of oral physiological values further includes a set of pressure values.

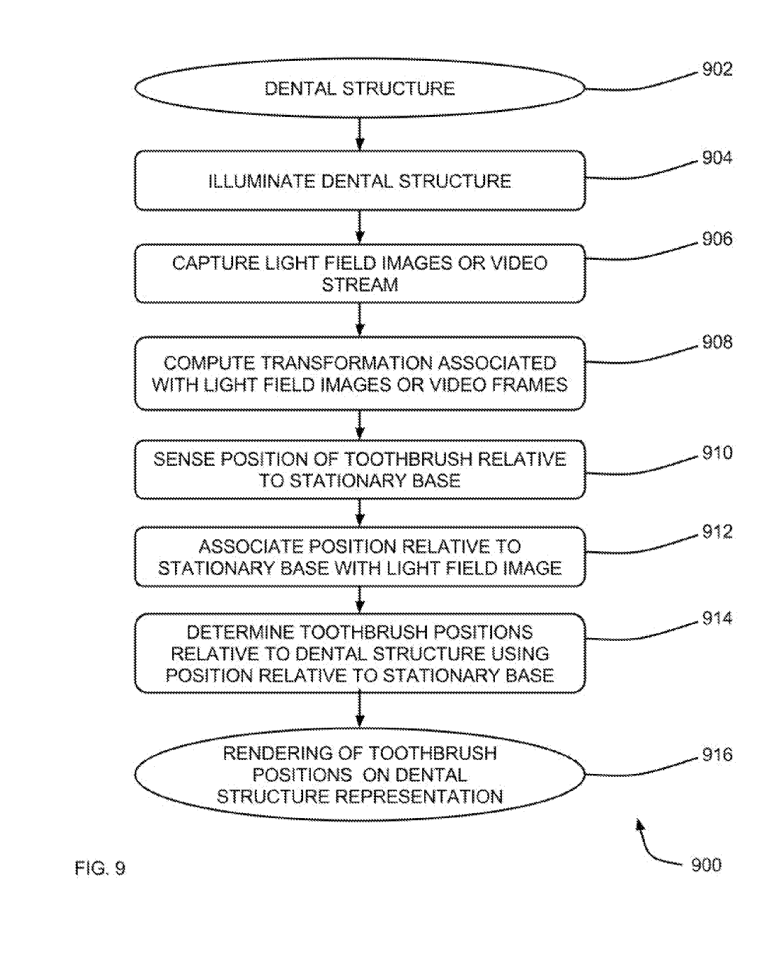

FIG. 9 is a flowchart of method 900 to render the three dimensional positions of a toothbrush on a visual representation of a user's dentition. Method 900 solves the need in the art to visualize the three dimensional position of a toothbrush relative to a user's dentition while brushing.

Method 900 includes a dental structure being brushed 702, illuminating the dental structure 904, capturing a set of light field images or video stream of the dental structure 906, computing a transformation associated with each light field image in the set 908 wherein the transformation is relative to the dental structure, sensing the three dimensional position of the toothbrush relative to a stationary base 910, associating the three dimensional position of the toothbrush relative to the stationary base with a light field image 912, determining a set of positions of the toothbrush relative to the dental structure 914 based on the transformation associated with each light field image in the set and the associated three dimensional position of the toothbrush relative to the stationary base, and yielding a rendering of the three dimensional positions of the toothbrush relative to a representation of the dental structure 916.

In some aspects, determining the three dimensional positions of the toothbrush relative to the stationary reference further includes transmitting a set of signal, receiving the set of signals at the stationary reference, and determining the set of three dimensional positions of the toothbrush relative to the stationary reference based on the difference in arrival time of each signal in the set of signals. In other aspects, determining the three dimensional positions of the toothbrush relative to the stationary reference further includes transmitting a set of signal, receiving the set of signals at the stationary reference, and determining the set of three dimensional positions of the toothbrush relative to the stationary reference based on the attenuation of each signal in the set of signals. In some aspects, the set of signals further includes a set of infrared signals. In other aspects, the set of signals further includes a set of radiofrequency signals. In yet other aspects, the set of signals further includes a set of acoustic signals.

### CONCLUSION

A system to track the three dimensional position of a toothbrush relative to a user's dentition is described. Although specific aspects are illustrated and described herein, it will be appreciated by those of ordinary skill in the art that any arrangement which is calculated to achieve the same purpose may be substituted for the specific aspects shown. This application is intended to cover any adaptations or variations. For example, although described in terms of an illumination system and light field camera, one of ordinary skill in the art will appreciate that implementations can be made using any other system capable of constructing a three dimensional map of a dental structure. Additionally, although described in terms of physiological signals such as temperature, pH, or pressure, one of ordinary skill in the art will appreciate that implementations can also be made that reflect any other signal of interest that can be acquired or derived from sensors embedded within a toothbrush, such as a signal that reflects tooth decay, gingival recession, or enamel thickness.

In particular, one of skill in the art will readily appreciate that the names of the methods and apparatus are not intended to limit aspects. Furthermore, additional methods and apparatus can be added to the components, functions can be rearranged among the components, and new components to correspond to future enhancements and physical devices used in aspects can be introduced without departing from the scope of aspects. One of skill in the art will readily recognize that aspects are applicable to future physiological and oral signals that can be acquired, derived or interpreted, different methods of acquiring three dimensional scan and position tracking data, and new algorithms to infer three dimensional positions from a light field image.

The terminology used in this application is meant to include all systems to track the three dimensional position of a toothbrush and index various acquired oral signal data using the tracked position, and alternate technologies which provide the same functionality as described herein.

What is claimed:

1. A toothbrush system comprising:
a handle;
a brush head;
an illumination system embedded within the brush head;
a camera system embedded within the brush head, operable to acquire a set of light field images;
a set of machine readable instructions embodied in a non-transitory computer readable storage medium, operable to receive the set of light field images, and further operable to determine a relative transformation of the camera system associated with each light field image in the set.

2. The toothbrush system of claim 1 wherein the illumination system further comprises a set of illumination elements operable to project a pattern.

3. The toothbrush system of claim 2 wherein the camera system further comprises a camera system operable to acquire a set of light field images, wherein each light field image in the set captures the pattern projected by the illumination system.

4. The toothbrush system of claim 3 wherein the set of machine readable instructions is further operable to:
construct a set of images with varying focal depth associated with each light field image in the set of light field images, wherein each image in the set of images with varying focal depth captures the illumination pattern captured in each light field image as a set of edges;
extract the set of edges in each image of varying focal depth and compute an edge strength corresponding to each edge; and
construct a point cloud associated with each light field image, based on the set of edges and corresponding edge strengths associated with each image in the set of images with varying focal depth.

5. The toothbrush system of claim 4 wherein the set of machine readable instructions is further operable to:
compute a rigid transformation associated with each point cloud relative to the first point cloud and based on the partial overlap between pairs of point clouds; and
determine the relative transformation of the camera system associated with each light field image in the set based on the rigid transformation associated with each point cloud.

6. The toothbrush system of claim 2 wherein each illumination element further comprises:
a light source; and
a grating.

7. The toothbrush system of claim 1 further comprising:
a visualization system, operable to receive the relative transformation of the camera system, and further operable to render a representation of the brush head within a virtual 3D space, based on the relative transformation of the camera system.

8. The toothbrush system of claim 1 wherein the brush head further comprises:
a set of bristles, wherein the set of bristles do not occlude the view of the camera system, and wherein the set of bristles is comprised of individual bristle bundles; and
an optically transparent protective covering over the camera system and illumination system.

9. The toothbrush system of claim 8 wherein the brush head further comprises a set of pressure sensors operable to measure the pressure applied to each bristle bundle in the set of bristles.

10. The toothbrush system of claim 8 wherein the brush head further comprises a temperatures sensor.

11. The toothbrush system of claim 8 wherein the brush head further comprises a pH sensor.

12. The toothbrush system of claim 2 wherein the brush head further comprises:
a set of bristles, wherein the set of bristles do not occlude the view of the camera system, and wherein the set of bristles do not occlude the projection of the illumination pattern; and
an optically transparent protective covering over the camera system and illumination system.

13. The toothbrush system of claim 12 wherein the brush head further comprises a set of pressure sensors operable to measure the pressure applied to each bristle bundle in the set of bristles.

14. The toothbrush system of claim 12 wherein the brush head further comprises a temperatures sensor.

15. The toothbrush system of claim 12 wherein the brush head further comprises a pH sensor.

16. The toothbrush system of claim 2 wherein the brush head further comprises:
an internal shaft in which the camera system and illumination system are embedded;
a disposable outer housing, wherein the disposable outer housing can be removed and reattached from the internal shaft.

17. The toothbrush system of claim 16 wherein the disposable outer housing further comprises:
a set of bristles, wherein the set of bristles do not occlude the view of the camera system, and wherein the set of bristles do not occlude the projection of the illumination pattern; and
an optically transparent protective covering over the camera system and illumination system embedded within the internal shaft.

18. The toothbrush system of claim 17 wherein the internal shaft further comprises a set of pressure sensors operable to measure the pressure applied to each bristle bundle in the set of bristles of the disposable outer housing.

19. The toothbrush system of claim 17 wherein the internal shaft further comprises a temperature sensor.

20. The toothbrush system of claim 19 wherein the outer housing further comprises a conducting material coupled to the temperature sensor and operable to transmit temperature changes to the temperature sensor.

21. The toothbrush system of claim 19 wherein the outer housing further comprises an opening coupled to the temperature sensor and wherein the temperature sensor is isolated from the other components of the internal shaft.

22. The toothbrush system of claim 17 wherein the internal shaft further comprises a pH sensor.

23. The toothbrush system of claim 22 wherein the outer housing further comprises an opening coupled to the pH sensor and wherein the pH sensor is isolated from the other components of the internal shaft.

24. The toothbrush system of claim 1 further comprising a stationary base operable to sense the position of the brush head relative to the stationary base.

25. The toothbrush system of claim 24 wherein the handle further comprises a first transceiver operable to emit and receive a set of signals, and wherein the stationary base further comprises a second transceiver operable to emit and receive the set of signals and further operable to determine the position of the brush head relative to the stationary base, based on the set of signals.

26. A method of tracking the position of a toothbrush as it brushes a dental structure comprising:
illuminating the dental structure;
capturing a set of light field images of the dental structure;
computing a transformation associated with each light field image in the set wherein the transformation is relative to the dental structure; and
determining a set of positions of the toothbrush relative to the dental structure based on the transformation associated with each light field image in the set.

27. The method of claim 26 wherein illuminating the dental structure further comprises:
illuminating the dental structure with a pattern of light.

28. The method of claim 27 wherein capturing a set of light field images further comprises capturing a set of light field images wherein each light field image captures the pattern of light.

29. The method of claim 28 wherein computing a transformation associated with each light field image further comprises:
constructing a set of images with varying focal depth associated with each light field image in the set of light field images, wherein each image in the set of images with varying focal depth captures the pattern of light captured in each light field image as a set of edges;
extracting the set of edges in each image of varying focal depth and compute an edge strength corresponding to each edge; and
constructing a point cloud associated with each light field image, based on the set of edges and corresponding edge strengths associated with each image in the set of images with varying focal depth.

30. The method of claim 29 wherein determining a transformation of the camera system further comprises:
computing a rigid transformation associated with each point cloud relative to the first point cloud and based on the partial overlap between pairs of point clouds; and
determining the relative transformation associated with each light field image in the set based on the rigid transformation associated with each point cloud.

31. The method of claim 30 wherein computing a rigid transformation associated with each point cloud further comprises:
iteratively computing a point cloud representing the dental structure.

32. The method of claim 26 further comprising:
sensing a set of oral physiological values;
associating each oral physiological value in the set with a light field image based on the time the oral physiological value was sensed relative to the time each light field image was acquired; and
associating each oral physiological value in the set with a position of the toothbrush based on the light field image the oral physiological value is associated with.

33. The method of claim 32 further comprising:
visualizing the point cloud representing the dental structure with a color map depicting the set of oral physiological values.

34. The method of claim 33 wherein the set of oral physiological values further comprise a set of pH values.

35. The method of claim 33 wherein the set of oral physiological values further comprise a set of temperature values.
